(19) United States
(12) Patent Application Publication
(10) Pub. No.: US 2023/0050458 A1
(43) Pub. Date: Feb. 16, 2023

(54) CELL SELECTION METHOD, CELL SELECTION CONTROL METHOD AND REATED DEVICE

(71) Applicant: VIVO MOBILE COMMUNICATION CO., LTD., Dongguan (CN)

(72) Inventors: Yanxia ZHANG, Dongguan (CN); Zhenhua XIE, Dongguan (CN)

(73) Assignee: VIVO MOBILE COMMUNICATION CO., LTD., Dongguan (CN)

(21) Appl. No.: 17/975,586

(22) Filed: Oct. 27, 2022

Related U.S. Application Data
(63) Continuation of application No. PCT/CN2021/089581, filed on Apr. 25, 2021.

(30) Foreign Application Priority Data
Apr. 30, 2020 (CN) 202010367083.3

(51) Int. Cl. H04W 48/20; H04W 48/16

(52) U.S. Cl. CPC H04W 48/20; H04W 48/16

(57) ABSTRACT

A cell selection method, a cell selection control method and a related device are provided. The cell selection method includes: obtaining cell assistance information of an access network; and performing a cell selection based on the cell assistance information and slice assistance information. The slice assistance information is used to assist in performing the cell selection.

### CROSS-REFERENCE TO RELATED APPLICATIONS

This application is a continuation of International Application No. PCT/CN2021/089581, filed on Apr. 25, 2021, which claims priority to Chinese Patent Application No. 202010367083.3 filed on Apr. 30, 2020. The entire contents of each of the above-referenced applications are expressly incorporated herein by reference.

### TECHNICAL FIELD

This application relates to the field of communications technologies, and in particular, to a cell selection method, a cell selection control method, and a related device.

### BACKGROUND

With development of communications technologies, in 5G New Radio (NR) system, a slice function is introduced. Currently, when a terminal (e.g., User Equipment (UE)) attempts to access a cell with a 5G access network, the terminal does not know whether the cell supports a certain network slice. Therefore, when an accessed cell is being selected, accessing the cell may fail. Therefore, in the prior art, a problem of low reliability of accessing a cell is present.

### SUMMARY

The embodiments of the present application provide a cell selection method, a cell selection control method, and a related device, to solve a problem of low reliability of accessing a cell.

According to a first aspect, an embodiment of the present application provides a cell selection method, applied to a terminal and including:

obtaining cell assistance information of an access network; and

based on the cell assistance information and slice assistance information, performing a cell selection, where the slice assistance information is used to assist in performing the cell selection.

According to a second aspect, an embodiment of the present application provides a cell selection control method, applied to a core network device and including:

sending slice assistance information to a terminal, where the slice assistance information is used to assist the terminal in performing a cell selection.

According to a third aspect, an embodiment of the present application provides a cell selection control method, applied to an access network device and including:

sending cell assistance information, where the cell assistance information is used to assist a terminal in selecting an accessed cell.

According to a fourth aspect, an embodiment of the present application provides a terminal, including:

an obtaining module, configured to obtain cell assistance information of an access network; and

a selection module, configured to perform a cell selection based on the cell assistance information and slice assistance information, where the slice assistance information is used to assist in performing the cell selection.

According to a fifth aspect, an embodiment of the present application provides a core network device, including a first sending module, configured to send slice assistance information to a terminal, where the slice assistance information is used to assist the terminal in performing a cell selection.

According to a sixth aspect, an embodiment of the present application provides an access network device, including:

a second sending module, configured to send cell assistance information, where the cell assistance information is used to assist a terminal in selecting an accessed cell.

According to a seventh aspect, an embodiment of the present application provides a terminal, including a memory, a processor, and a program or an instruction stored in the memory and capable of running on the processor, where when the program or the instruction is executed by the processor, the steps of the foregoing cell selection method are implemented.

According to an eighth aspect, an embodiment of the present application provides a network device, including a memory, a processor, and a program or an instruction stored in the memory and capable of running on the processor, where when the program or the instruction is executed by the processor, the steps of the foregoing cell selection control method are implemented.

According to a ninth aspect, an embodiment of the present application provides a readable storage medium, where the readable storage medium stores a program or an instruction, and when the program or the instruction is executed by a processor, the steps of the foregoing cell selection method are implemented, or when the program or the instruction is executed by a processor, the steps of the foregoing cell selection control method are implemented.

According to a tenth aspect, an embodiment of the present application provides a chip, where the chip includes a processor and a communications interface, the communications interface is coupled to the processor, and the processor is configured to run a program or an instruction, to implement the method according to the first aspect, the second aspect, or the third aspect.

According to an eleventh aspect, an embodiment of the present application provides a computer program product, stored in a readable storage medium, where the computer program product is executed by at least one processor to implement the steps of the foregoing cell selection method, or implement the steps of the foregoing cell selection control method.

According to a twelfth aspect, an embodiment of the present application provides a terminal, where the terminal is configured to implement the steps of the foregoing cell selection method.

According to a thirteenth aspect, an embodiment of the present application provides a network device, where the network device is configured to implement the steps of the foregoing cell selection control method.

The embodiments of the present application obtains the cell assistance information of the access network, and performs the cell selection based on the cell assistance information and the slice assistance information. In this way, the terminal can perform the cell selection that is sensed by the slice. Therefore, the embodiments of the present application improve the reliability of accessing the cell.

### BRIEF DESCRIPTION OF DRAWINGS

To describe the technical solutions in the embodiments of the present application more clearly, the following briefly describes the accompanying drawings required in the embodiments of the present application. Apparently, the accompanying drawings in the following descriptions show merely some embodiments of the present application, and a person of ordinary skill in the art may still derive other drawings from these accompanying drawings without creative efforts.

FIG. 1 is a structural diagram of a network system to which an embodiment of the present application may be applied;

FIG. 2 is a first flowchart of a cell selection method according to an embodiment of the present application;

FIG. 3 is a second flowchart of a cell selection method according to an embodiment of the present application;

FIG. 4 is a flowchart of a cell selection control method according to an embodiment of the present application;

FIG. 5 is a flowchart of another cell selection method according to an embodiment of the present application;

FIG. 6 is a structural diagram of a terminal according to an embodiment of the present application;

FIG. 7 is a structural diagram of a core network device according to an embodiment of the present application;

FIG. 8 is a structural diagram of an access network device according to an embodiment of the present application;

FIG. 9 is a structural diagram of another terminal according to an embodiment of the present application; and

FIG. 10 is a structural diagram of a network device according to an embodiment of the present application.

### DETAILED DESCRIPTION

The following describes the technical solutions in the embodiments of the present application with reference to the accompanying drawings in the embodiments of the present application. Apparently, the described embodiments are some but not all of the embodiments of the present application. All other embodiments obtained by a person of ordinary skill in the art based on the embodiments of the present application without creative efforts shall fall within the protection scope of the present application.

The term “include” and any other variants in the specification and claims of the present application mean to cover the non-exclusive inclusion, for example, a process, method, system, product, or device that includes a list of steps or units is not necessarily limited to those steps or units, but may include other steps or units not expressly listed or inherent to such a process, method, product, or device. In addition, “and/or” used in the description and the claims means at least one of the connected objects. For example, A and/or B represents the following three cases: Only A exists, only B exists, and both A and B exist.

In the embodiments of the present application, the word such as “example” or “for example” is used to represent giving an example, an illustration, or a description. Any embodiment or design scheme described as “an example of” or “for example” in the embodiments of the present application should not be explained as being more preferred or having more advantages than another embodiment or design scheme.

The following describes the embodiments of the present application with reference to the accompanying drawings. A cell selection method, a cell selection control method, and a related device provided in the embodiments of the present application may be applied to a wireless communications system. The wireless communications system may be a 5G system, an evolved Long Term Evolution (eLTE) system, or a subsequent evolved communications system.

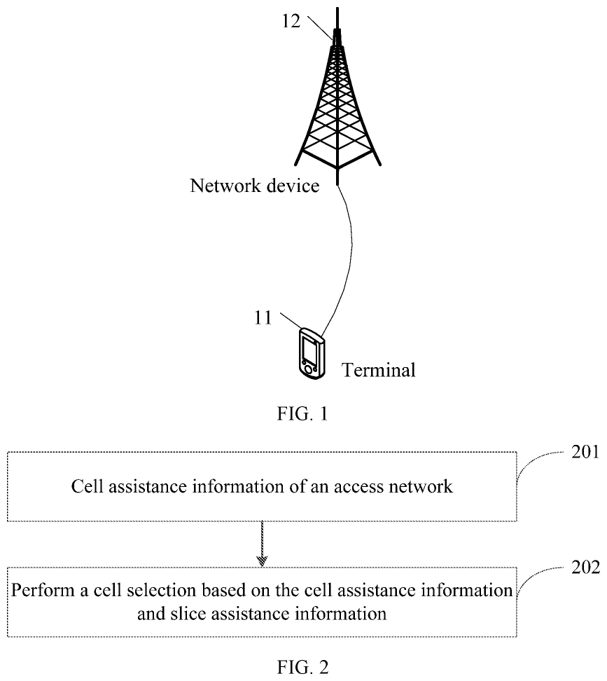

Referring to FIG. 1, FIG. 1 is a structural diagram of a network system to which an embodiment of the present application may be applied. As shown in FIG. 1, the network system includes a terminal 11 and a network device 12. The terminal 11 may be a user terminal or another terminal-side device, for example, a mobile phone, a tablet personal computer, a laptop computer, a Personal Digital Assistant (PDA), a Mobile Internet Device (MID), or a wearable device. It should be noted that a type of the terminal 11 is not limited in the embodiments of the present application. The network device 12 may be a 5G base station, a base station of a subsequent version, or a base station in another communications system, or may be referred to as a NodeB, an evolved NodeB, a Transmission Reception Point (TRP), an Access Point (AP), or other terms in the art. In addition, the network device 12 may be a Master Node (MN) or a Secondary Node (SN). It should be noted that, in the embodiments of the present application, the 5G base station is merely used as an example, but the network device is not limited to any specific type.

For ease of understanding, the following describes some content involved in the embodiments of the present application.

A network slice is a concept that allows a different treatment according to a requirement of each client. In a form of a slice, different traffic is differentiated, and a resource may be isolated. A mobile network operator may treat a client as a client belonging to different user types, and each client has different service requirements. These service requirements manage which types of slice a user may use through a Service Level Agreement (SLA) and a subscription.

To identify an end-to-end network slice, each network slice is uniquely identified by Single Network Slice Selection Assistance Information (S-NSSAI). Each piece of S-NSSAI is composed of a Slice/Service Type (SST) and a Slice_differentiator (SD).

The network slice is always composed of a Radio Access Network (RAN) and a Core Network (CN). The support of network slices depends on the following principle: traffic of different slices is handled by different Protocol Data Unit (PDU) sessions. A network can implement different network slices by scheduling and providing different layer 1 (L1)/layer 2 (L2) configurations.

UE does not know whether a RAN supports a slice when trying to access the RAN. The UE may carry one or a plurality of pieces of requested NSSAI in a Radio Resource Control (RRC) connection setup complete message, including S-NSSAI of the network slice that the UE wants to register. The RAN selects an appropriate Access and Mobility Management Function (AMF) based on the requested NSSAI provided by the UE. If the RAN fails to make a selection, a default AMF is selected. The failure of the RAN to make a selection may be understood as: that the UE does not provide the requested NSSAI or that the UE provides the requested NSSAI, but the RAN fails to find an AMF that matches the ability of the requested NSSAI

The AMF determines which piece of requested S-NSSAI may be allowed based on the requested NSSAI provided by the UE, slice subscription information of the UE (for example, subscribed NSSAI), and a RAN-side slice configuration.

Referring to FIG. 2, FIG. 2 is a flowchart of a cell selection method according to an embodiment of the present application. The method is applied to a terminal. As shown in FIG. 2, the method includes the following steps.

Step 201: Obtain cell assistance information of an access network.

In this embodiment, the access network can send the cell assistance information in the form of broadcasting. The terminal can obtain the cell assistance information of the access network. For example, the cell assistance information may be a system message broadcast by the access network. The cell assistance information may also be understood as cell assistance information sensed by a slice. The cell assistance information sensed by a slice is used to assist the terminal in a cell selection.

Step 202: Perform a cell selection, based on the cell assistance information and slice assistance information, where the slice assistance information is used to assist in performing the cell selection.

In this embodiment, performing a cell selection may be understood as a corresponding behavior of the cell selection. The behavior of the cell selection may include a selection of an accessible cell (for example, suitable cell). The cell selection may be understood as an initial cell selection or a cell reselection, which is not further limited herein. It should be understood that after an accessed cell is selected, the terminal may request an access to a network through the cell. In an embodiment, the cell assistance information may be matched with the slice assistance information, to determine a cell that meets requirements of the terminal.

This embodiment of the present application performs the cell selection based on the cell assistance information and slice assistance information, by obtaining the cell assistance information of the access network. In this way, the terminal can implement the cell selection sensed by the slice. Therefore, this embodiment of the present application improves the reliability of accessing the cell.

It should be understood that the slice assistance information may be information that is pre-configured or sent by a core network. In this embodiment, after the terminal accesses the network of the cell through the access network, the core network can provide the latest slice assistance information to the UE. In some embodiments, the slice assistance information may include at least one of the following:

a correspondence between a slice and a slice index;

a slice index list;

a correspondence between the slice and a slice group index;

a slice group index list;

a correspondence between the slice and a cell;

a cell identity (cell ID) list;

a correspondence between the slice and a tracking area;

a tracking area identity list;

a correspondence between the slice and a core network routing function;

a core network routing function index list;

a correspondence between the slice and a frequency (FN);

a frequency list;

a correspondence between the slice and a Frequency Band (FB); and

a frequency band list.

In this embodiment, the correspondence between the slice and the slice index may be understood as that one slice index corresponds to one slice. The slice index list may include all or part of a slice index in the correspondence between the slice and the slice index. For example, in an embodiment, when one slice index corresponds to one slice, following correspondences may be present: a slice index 1 corresponds to a slice_a, a slice index 2 corresponds to a slice_b, a slice index 3 corresponds to a slice_c, a slice index 4 corresponds to a slice_d, and a slice index 5 corresponds to a slice_e.

It should be understood that the correspondence between the slice and the slice index may be configured for a Public Land Mobile Network (PLMN), a Tracking Area (TA), or a Registration Area (RA). For example, in an embodiment, the correspondence between the slice and the slice index includes at least one of the following.

In this embodiment, one correspondence between a slice and a slice index may be configured for each tracking area or registration area, that is, the corresponding relationship between a slice and a slice index may be configured for a value of each TA or RA. The correspondence between a slice and a slice index may include a one-to-one correspondence between M1 slice indexes and M1 slices and a correspondence between M2 slice indexes and M2 slice combinations. M1 and M2 are integers, and the sum of M1 and M2 is greater than 1.

The correspondence between a slice and a slice group index may be understood as that one slice group index corresponds to one or a plurality of slices. The slice group index list may include all or part of a slice group index in the correspondence between a slice and a slice index. For example, in an embodiment, when one slice index corresponds to one slice combination, following correspondences may be present: a slice index 1 corresponds to a slice_a and a slice_b, a slice index 2 corresponds to a slice_a and a slice_c, a slice index 3 corresponds to a slice_c, a slice_d, and a slice_e.

The correspondence between a slice and a cell may be understood as an association relationship between a cell supporting a slice and the slice. Each cell may support one or a plurality of slices. A cell supporting the same slice may include one or a plurality of cells. For example, a slice and a cell may have following correspondences: a slice_a corresponds to a cell 1, a cell 2, and a cell 3, a slice_b corresponds to a cell 2, a cell 3, and a cell 4, and a slice_c corresponds to a cell 1, a cell 2, a cell 3, and a cell 4.

The correspondence between a slice and a tracking area may be understood as an association relationship between a tracking area supporting a slice and the slice. Each tracking area may support one or a plurality of slices. A tracking area supporting the same slice may include one or a plurality of tracking areas.

The correspondence between a slice and a core network routing function may be understood as an association relationship between a route supporting a slice and the slice. Each slice route (slice combination) in a slice routing group of the core network routing function may support one or a plurality of slices, and the route supporting the same slice may include one or a plurality of routes. In some embodiments, the slice routing group may be represented by <AMFm, . . . , AMFn>, <AMF SETm, . . . , AMF SETn>, or <AMF SETa, . . . , AMF SETb, AMFm, . . . , AMFn, . . . >, which is not further limited herein.

The correspondence between a slice and a frequency may be understood as an association relationship between a frequency supporting a slice and the slice. One or a plurality of slices may be supported at each frequency. A frequency supporting the same slice may include one or a plurality of frequencies. For example, a slice and a frequency may have following correspondences: a slice_a corresponds to a frequency 1, a frequency 2, and a frequency 3, a slice_b corresponds to a frequency 2, a frequency 3, and a frequency 4, and a slice_c corresponds to a frequency 1, a frequency 2, a frequency 3, and a frequency 4.

The correspondence between a slice and a frequency band may be understood as an association relationship between a frequency band supporting a slice and the slice. One or a plurality of slices may be supported at each frequency band. The frequency band supporting the same slice may include one or a plurality of frequency bands. For example, a slice and a frequency band may have following correspondences: a slice_a corresponds to a frequency 1, a frequency 2, and a frequency band 3, a slice_b corresponding to a frequency band 2, a frequency band 3, and a frequency band 4, a slice_c corresponds to a frequency band 1, a frequency band 2, a frequency band 3, and a frequency band 4.

It should be noted that in this embodiment of the present application, the slice assistance information may include a correspondence between an object and a slice, and may also include list information corresponding to the object. When the slice assistance information only includes the list information corresponding to the object, slice information does not need to be informed, thereby improving the security of the network slice. The object may be understood as a cell, a tracking area, a core network route, a frequency, or a frequency band. The list information corresponding to the object may be understood as a cell identity list, a tracking area identity list, a core network routing function index list, a frequency list, or a frequency band list.

Further, the cell assistance information includes at least one of the following:

cell identity information;

tracking area identity information;

core network routing function index information;

slice index information;

slice group index information;

frequency information; and

frequency band information.

It should be understood that in this embodiment, the slice assistance information includes at least one of the following:

selecting an accessed cell in a first cell, where cell assistance information of the first cell overlaps slice related information, and the slice related information includes part or all of the slice assistance information; and

setting a second cell as an access-forbidden cell, or setting a frequency of the second cell as an access-forbidden frequency, where cell assistance information of the second cell does not overlap the slice related information.

It should be understood that the cell assistance information of the first cell overlapping the slice related information may be understood as that at least one piece of information in the cell assistance information of the first cell is included in the slice related information. The cell assistance information of the second cell skipping overlapping the slice related information may be understood as that any piece of information in the cell assistance information of the second cell is not included in the slice related information. Using a case in which the slice assistance information and the slice related information are all a slice index as an example, if a slice index=1, and 2 is included in the slice related information, and a slice index=1, and/or a slice index=2 are included in the cell assistance information, it is considered that the cell assistance information overlaps the slice related information of the cell. Otherwise, it is considered that the cell assistance information does not overlap the slice related information.

In this embodiment, the slice related information includes at least one of cell identities, a tracking area identity, a slice index, a frequency, and a frequency band. The slice related information is determined based on the slice assistance information, and may include part or all of the slice assistance information. In some embodiments, the slice related information may be information that is determined by a Non-Access Stratum (NAS) of the terminal, and provided to an AS stratum.

In some embodiments, the slice related information may be understood as a cell identity, a tracking area identity, a slice index, a frequency, and a frequency band that are associated with a slice to which the terminal expects to access.

It should be noted that the access network may also send slice support information to a core network. The core network generates slice routing information based on the slice support information, and sends the slice routing information to an access network. The access network may generate the cell assistance information based on the slice routing information.

The slice routing information includes at least one of the following:

a core network routing function index list;

a slice index list; and

a slice group index list.

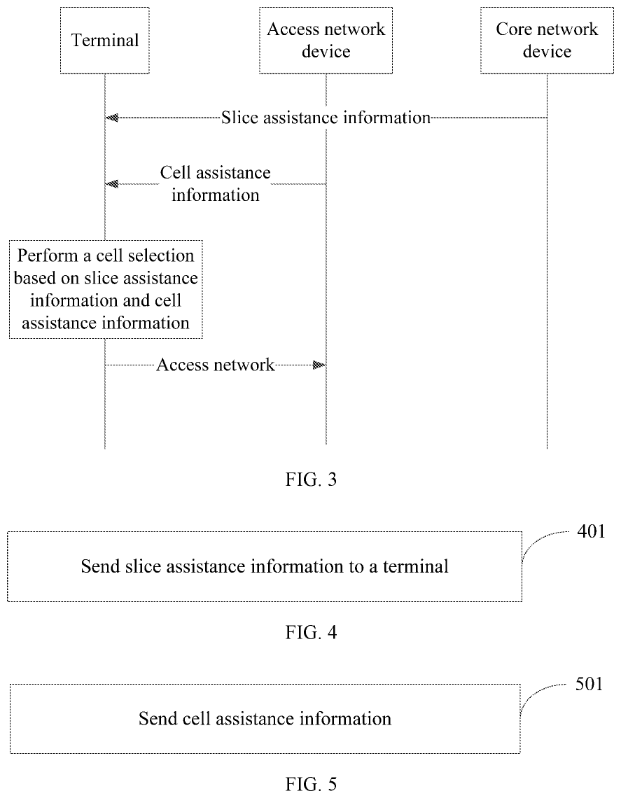

To better understand the present application, the implementation of the present application is described in detail below with reference to FIG. 3. As shown in FIG. 3, the following steps may be included.

Step 1: UE obtains assistance information of a cell selection and reselection sensed by a slice. The assistance information of a cell selection and reselection sensed by a slice includes:

slice assistance information; and

cell assistance information.

The slice assistance information may be pre-configured cell selection and reselection assistance information sensed by a slice that is configured or reconfigured by a core network. For example, when the UE accesses a network successfully, the core network provides the latest cell selection assistance information to the UE. In an embodiment, the slice assistance information may be any one of the following.

Solution 1: A mapping relationship of slice index-to slice. For example, a mapping relationship of slice index-to slice supported by a network side may be that: a slice index 1 corresponds to a slice_a, a slice index 2 corresponds to a slice_b, a slice index 3 corresponds to a slice_c, a slice index 4 corresponds to a slice_d, and a slice index 5 corresponds to a slice_e. If a slice allowed by UE includes a slice_b, a slice_c, and a slice_d, a mapping relationship provided by a network side to the UE is: {<slice_b, 2>, <slice_c, 3>, <slice_d, 4>}, in other words, a slice index 2 corresponds to a slice_b, a slice index 3 corresponds to a slice_c, and a slice index 4 corresponds to a slice_d.

The mapping relationship of slice index-to slice may be configured for per PLMN, per TA, or per RA. For example, under a PLMN 1, the mapping relationship of slice index-to slice is that the slice index=1, 2, 3, 4, and 5; respectively corresponding to slice=a slice_a, a slice_b, a slice_c, a slice_d, and a slice_e. Under a PLMN2, the mapping relationship of slice index-to slice is that the slice index=2, 3, 4 and 5, respectively corresponding to slice=a slice_b, a slice_c, a slice_d, and a slice_e. Similarly, when the mapping relationship is configured based on per TA or per RA, the network side configures a mapping relationship of slice index-to slice for a value of per TA or RA.

Solution 2: A mapping relationship of slice index-to-slice combination, where the slice index corresponds to a slice combination. A slice may correspond to a plurality of slice combinations, and a slice combination includes a plurality of slices. For example, the mapping relationship of slice index-to slice supported by the network side is that: a slice index=1 corresponds to a slice=a slice_a and a slice_b, a slice index=2 corresponds to a slice=slice_a and a slice_c, and a slice index=3 corresponds to a slice 3=a slice_c, a slice_d, and a slice_e.

If a slice allowed by UE=a slice_a and a slice_b, a mapping relationship of slice index-to-slice combination configured by the network side for the UE includes that: a slice index=1 corresponds to a slice=a slice_a and a slice_b, a slice index=2 corresponds to a slice=a slice_a and a slice_c, or {<slice_a,(1,2)>, <slice_b,(1)>}. In other words, the slice combination index corresponding to the slice_a is 1 and 2, and the slice combination index corresponding to the slice_b is 1.

If the slice allowed by UE=a slice_a, a slice_c, and a slice_d, the mapping relationship of slice index-to-slice combination configured by the network side for UE includes that: a slice index=1 corresponds to a slice=a slice_a and a slice_b, a slice index=2 corresponds to a slice=a slice_a, and a slice_c, a slice index=3 corresponds to a slice=a slice_c, a slice_d, and a slice_e, or {<slice_a,(1,2)>, <sliceb,(1)>, <slice_c,(2,3)>}. In other words, the slice combination index corresponding to the slice_a is 1 and 2, and the slice combination index corresponding to the slice_b is 1, and the slice combination index corresponding to the slice_c is 2 and 3.

In some embodiments, the mapping relationship of slice index-to-slice may be configured by per PLMN, per TA, or per RA. The RA may be composed of one or a plurality of TAs.

Solution 3: A slice index list, where the slice index corresponds to a slice combination. For example, the mapping relationship of slice index-to slice supported by the network side is that a slice index=1 corresponds to a slice=a slice_a and a slice_b, a slice index=2 corresponds to a slice=a slice_a and a slice_c, and a slice index=3 corresponds to a slice 3=a slice_c, a slice_d and a slice_e. If the slice allowed by UE=a slice_a and a slice_b, the slice index configured by the network side for the UE is a slice index=1 and 2. If the slice allowed by the UE=a slice_a, a slice_b, and a slice_d, the slice index configured by the network side for the UE is a slice index: 1, 2 and 3.

Solution 4: A mapping relationship of slice-to-cell ID. A slice may correspond to a plurality of cells, and a cell may correspond to a plurality of slices. For example, a cell of the slice_a supported by the network side is that a cell ID=1, 2, and 3, a cell of the slice_b is that a cell ID=2, 3, and 4, a cell of the slice_c is that a cell ID=1, 2, 3, and 4. If the slice allowed by UE=a slice_b and a slice_b, the mapping relationship of slice-to-cell ID configured by the network side for the UE includes that: {<slice_a,(1,2,3)>, <slice_b,(2,3,4)>, <slice_c, (1,2,3,4)>}. In other words, a slice=a slice_a corresponds to cell ID=1, 2, and 3, and a slice=a slice_b corresponds to cell ID=2, 3, and 4.

Solution 5: Slice-to-routing index. A slice may correspond to a plurality of routes, and a route may correspond to a plurality of slices. For example, the network side sets <AMFm, . . . , AMFn> or <AMF SETm, . . . , AMF SETn> or <AMF SETa, . . . , AMF SETb, AMFm, . . . , AMFn, . . . > as a slice routing group, and the corresponding slice routing index is 1, and so on. If the UE allows access to the slice_a and the slice_b, the mapping relationship of slice-to-slice routing index configured by the network side for the UE is that: {<slice_a, (1,2)>, <slice_b, (4)>}. The slice routing group corresponding to the slice routing index=1 or 2 includes an AMFk or an AMF SETk. The AMFk or the AMF SETk support and serve the slice_a. Similarly, the meaning of the relationship between the slice_b and the slice routing index=4 may be learned.

Solution 6: A mapping relationship of slice-to-frequency. A slice may correspond to a plurality of frequencies, and a cell may correspond to a plurality of frequencies. For example, the slice supported by the network side is a slice_a, a slice_b. The corresponding frequencies are (FN1, FN2, FN3), (FN4, FN5) respectively. If the UE allows access to the slice_a, the slice_b, the slice assistance information provided by the network side to the UE is that {<slice_a, (FN1, FN2, FN3)>, <slice_b (FN4, FN5)>}. Different slices may correspond to a same frequency set.

Solution 7: A mapping relationship of slice-to-frequency band. A slice may correspond to a plurality of frequency bands, and a cell may correspond to a plurality of frequency bands. For example, the slice supported by the network side is a slice_a, a slice_b, and a slice_c. The corresponding frequency bands are (FB1, FB2), FB3, and (FB1, FB4, FB5). If the UE allows access to the slice_b, and the slice_c, the slice assistance information provided by the network side to the UE is {<slice_b, (FB3)>, <slice_c, (FB 1, FB4, FB5)>}. Different slices may correspond to a same frequency band set.

Solutions 1 to 7 may be combined, that is, a slice may correspond to a variety of information that may be used in cascade. For example, the slice assistance information is {slice_a, (FN1, FN2), (cell id2, cell id5), (slice routing index 1, 3), (FB1, FB3)}.

Solution 8: Similar to solution 3, the slice assistance information may not include slice information. For example, the slice assistance information provided to the UE is {(FN1, FN2), (cell id2, cell id5), (slice routing index 1, 3), (FB1, FB3)}.

In some embodiments, the cell assistance information may be one or a plurality of slice indexes. The slice index corresponds to one slice or a slice combination. The slice index may be provided by per PLMN or per TA. The UE obtains the one or the plurality of slice indexes by using a broadcast message.

In some embodiments, the cell assistance information may be one or a plurality of routing indexes. The routing index may be provided by per cell. For example, a cell a provides a routing index=1 and 2 supported by the cell a. The routing index=1 corresponds to the slice routing group <AMF1, AMF2>, and routing index=2 corresponds to the slice routing group <AMF1, AMF2, AMF SET1>.

In some embodiments, the cell assistance information may be one piece or a plurality of pieces of frequency information, where the frequency information may be provided by per cell. For example, a cell a provides frequency information supported by the cell a, where the frequency information includes a frequency 1 and a frequency 2.

In some embodiments, the cell assistance information may be one piece or a plurality of pieces of frequency band information, where the frequency band information may be provided by per cell. For example, a cell a provides frequency information supported by the cell a, where the frequency information includes a frequency band 1 and a frequency band 2.

For example, a slice index=1, 2, 3, 4, and 5 supported by the PLMN 1 respectively corresponds to the slice=a slice_a, a slice_b, a slice_c, a slice_d, and a slice_e. If the slice supported by a gNB1 under the PLMN1=a slice_c, a slice_d, and a slice_e, the slice index corresponding to the broadcast slice supported by the PLMN1 is that the slice index=3, 4, and 5.

For example, the slice combination 1 corresponding to the slice index=1 supported by the PLMN1 includes that the slice=a slice_a and a slice_b. The slice combination 2 corresponding to the slice index=2 supported by the PLMN1 includes that the slice=a slice_a and a slice_c. The slice combination 3 corresponding to the slice index=1 supported by the PLMN1 includes that the slice=a slice_c, a slice_d, and a slice_e. If the slice supported by the gNB1 under the PLMN1=a slice_a and a slice_b, the slice index corresponding to the slice combination 1 and slice combination 2 supported by the broadcast PLMN1 includes: the broadcast slice index=1 and 2.

Step 2: The UE performs a cell selection based on slice assistance information and cell assistance information.

In some embodiments, the UE performs the cell selection based on slice related information. The slice related information is generated by the UE based on pre-configured slice assistance information provided by the core network. Examples of the behaviors of the UE are as follows:

In solution 1 of step 1, the UE NAS provides the UE AS with slice related information. The slice related information may be slice index (s). The UE selects a cell whose cell assistance information (for example, slice index) overlaps the slice related information as a candidate cell. The UE may select a cell that has broadcast all the slice index (s) as a candidate cell for the cell selection and reselection. The UE may also set a cell whose cell assistance information does not overlap the slice related information or a frequency corresponding to the cell as an access-forbidden cell or frequency, or an accessed cell or frequency with low priority. For example, the slice index-to-slice of the UE configured by the core network that is under the PLMN1 is that the slice index=1 and 2, respectively corresponding to the slice=a slice_a and a slice_b. The UE NAS instructs the UE AS to access the slice index=1 under the PLMN1. If the slice information of PLMN 1 broadcast by the cell is that the slice index=2 and 3, the UE considers the cell to be an access-forbidden cell, or considers the frequency band corresponding to the cell to be an access-forbidden frequency. If the slice information of PLMN1 broadcast by the cell is that the slice index=1 and 2, the UE takes the cell as a candidate cell for the cell selection and reselection.

In solution 2 of step 1, The UE NAS provides UE AS with slice related information. The slice related information may be slice index (s). The UE selects a cell whose cell assistance information (for example, slice index) overlaps the slice related information as a candidate cell. The UE may select a cell that has broadcast all the slice index (s) as a candidate cell for the cell selection and reselection. The UE may also set a cell whose cell assistance information does not overlap the slice related information or a frequency corresponding to the cell as an access-forbidden cell or frequency, or an accessed cell or frequency with low priority. For example, the mapping relationship of slice index-to-slice combination under the PLMN1 configured by the network side for the UE is that the slice index=1 corresponds to the slice=a slice_a and slice_b. The slice index=2 corresponds to the slice=a slice_a and a slice_c. The UE wants to access the slice=slice_a. The NAS instructs the UE AS to access slice index=1 and 2 under the PLMN1. If the slice information of the PLMN1 broadcast by the cell is slice index=1 and/or slice index=2, the UE takes the cell as a candidate cell for the cell selection and reselection. The UE wants to access slice=slice_c. The NAS instructs the UE AS to access slice index=2 under the PLMN1. If the slice information of the PLMN1 broadcast by the cell is slice index=2, the UE takes the cell as a candidate cell for the cell selection and reselection. If the slice information of the PLMN1 broadcast by the cell does not include slice index=2, the UE considers the cell to be an access-forbidden cell, or considers the frequency band corresponding to the cell to be an access-forbidden frequency.

In solution 3 of step 1, The UE NAS provides UE AS with slice related information. The slice related information may be slice index (s). The UE selects a cell whose cell assistance information (for example, slice index) overlaps the slice related information as a candidate cell. The UE may select a cell that has broadcast all the slice index (s) as a candidate cell for the cell selection and reselection. The UE may also set a cell whose cell assistance information does not overlap the slice related information or a frequency corresponding to the cell as an access-forbidden cell or frequency, or an accessed cell or frequency with low priority. For example, the slice index under PLMN1 configured by the network side for the UE is slice index=1 and 2. The slice index=1 under PLMN1 on the network side corresponds to a combination of slice=slice_a and slice_b. The slice index=2 corresponds to a combination of slice=slice_a and slice_c. The slice index=3 corresponds to a combination of slice3=slice_c, a slice_d, and a slice_e. The NAS instructs the UE AS to access slice index=1 and 2 under the PLMN1. The UE takes the cell that broadcast slice index=1 and 2 as a candidate cell for the cell selection.

In solution 4 of step 1, The UE NAS provides UE AS with slice related information. The slice related information may be cell ID (s). The UE selects a cell whose cell assistance information (for example, cell ID) overlaps the slice related information as a candidate cell. The UE may select a cell that has broadcast any one of cell ID (s) as a candidate cell for the cell selection and reselection. The UE may also set a cell whose cell assistance information does not overlap the slice related information or a frequency corresponding to the cell as an access-forbidden cell or frequency, or an accessed cell or frequency with low priority. For example, the mapping relationship of slice-to-cell ID configured by the network side for the UE is that: the slice=1 corresponds to cell ID=1, 2, and 3. The slice=2 corresponds to cell ID=2, 3, and 4. The UE wants to access slice=1. The NAS instructs the UE AS to access cell ID=1, 2, and 3. The UE selects a cell with cell ID=1 or cell ID=2 or cell ID=3 as a candidate cell for the cell selection and reselection. The UE takes a cell whose cell ID is not equal to 1, 2 and 3 as an access-forbidden cell, or takes a frequency corresponding to the cell whose cell ID is not equal to 1, 2 and 3 as an access-forbidden frequency.

In solution 5 of step 1, The UE NAS provides UE AS with slice related information. The slice related information may be core network routing function index (s). The UE selects a cell whose cell assistance information (for example, core network routing function index) overlaps the slice related information as a candidate cell. The UE may select a cell that has broadcast any one of the core network function index (s) as a candidate cell for the cell selection and reselection. The UE may also set a cell whose cell assistance information (for example, slice core network routing function index) does not overlap the slice related information or a frequency corresponding to the cell as an access-forbidden cell or frequency, or an accessed cell or frequency with low priority. For example, the slice-to-core network function routing identity list configured by the network for the UE is that routing index=1, 2, 3 and 4. The slice=slice_a corresponds to routing index=1, 2, and 3. The slice=slice_b corresponds to routing index=2, 3, and 4. The UE wants to access the slice_a. The UE NAS instructs the UE AS to access routing index=1, 2, and 3. The UE takes a cell that has broadcast any one of the routing indexes as a candidate cell. If the core network routing function index broadcast by the cell 1 is the routing index=1, the UE takes the cell as a candidate cell for the cell selection and reselection. If the cell has not broadcast any one of the routing index of the UE NAS, the UE considers the cell as an access-forbidden cell, or considers a frequency band corresponding to the cell as an access-forbidden frequency.

In solution 6 of step 1, The UE NAS provides UE AS with slice related information. The slice related information may be frequency information. The UE selects a cell whose cell assistance information (for example, frequency) overlaps the slice related information as a candidate cell. The UE may select a cell that has broadcast frequency information of any one of the frequencies as a candidate cell for the cell selection and reselection. The UE may also set a cell whose cell assistance information (for example, frequency corresponding to a cell) does not overlap the slice related information or a frequency corresponding to the cell as an access-forbidden cell or frequency, or an accessed cell or frequency with low priority. For example, the mapping relationship of slice index-to-frequency under the PLMN1 configured by the network side for the UE is that: the slice_a corresponds to FN1 and FN2, the slice_b corresponds to FN3, and the slice_c corresponds to FN1, FN4, and FN5. The UE wants to access slice=slice_a. The NAS instructs the UE AS to access FN1 and FN2 under the PLMN1. If the cell broadcasts frequency information of the PLMN1, including FN1 and/or FN2, the UE takes the cell as a candidate cell for the cell selection and reselection.

In solution 7 of step 1, The UE NAS provides UE AS with slice related information. The slice related information may be frequency band information. The UE selects a cell whose cell assistance information (for example, frequency band) overlaps the slice related information as a candidate cell. The UE may select a cell that has broadcast frequency band information of any one of the frequency band as a candidate cell for the cell selection and reselection. The UE may also set a cell whose cell assistance information (for example, frequency band information provided by a cell) does not overlap the slice related information or a frequency corresponding to the cell as an access-forbidden cell or frequency, or an accessed cell or frequency with low priority. For example, the mapping relationship of slice index-to-frequency band under PLMN1 configured by the network side for the UE is that: the slice_a corresponds to FB1 and FB2, the slice_b corresponds to FB3, and the slice_c corresponds to FB1, FB4, and FB5. The UE wants to access the slice=slice_a. The NAS instructs UE AS to access FB1 and FB2 under the PLMN1. If the cell has broadcasts frequency band information of the PLMN1, including FB1 and/or FB2, the UE takes the cell as a candidate cell for the cell selection and reselection.

In some embodiments, for an access-forbidden cell, the UE sets a duration during which the cell is forbidden to be accessed based on a network-side configuration or a protocol agreement. For example, the duration may be 300 seconds or always forbidden.

In some embodiments, for an access-forbidden frequency, the UE sets a duration during which the frequency is forbidden to be accessed based on a network-side configuration or a protocol agreement. For example, the duration may be 300 seconds or always forbidden.

Referring to FIG. 4, FIG. 4 is a flowchart of a cell selection control method according to an embodiment of the present application. The method is applied to a core network device. As shown in FIG. 4, the method includes the following step.

Step 401: Send slice assistance information to a terminal, where the slice assistance information is used to assist the terminal in performing a cell selection.

In some embodiments, the slice assistance information includes at least one of the following:

a correspondence between a slice and a slice index;

a slice index list;

a correspondence between the slice and a slice group index;

a slice group index list;

a correspondence between the slice and a cell;

a cell identity list;

a correspondence between the slice and a tracking area;

a tracking area identity list;

a correspondence between the slice and a core network routing function;

a core network routing function index list;

a correspondence between the slice and a frequency;

a frequency list;

a correspondence between the slice and a frequency band; and

a frequency band list.

In some embodiments, before the sending slice assistance information to a terminal, the method further includes:

sending slice routing information to an access network, where the slice routing information is used for the access network to generate cell assistance information, and the cell assistance information is used to assist the terminal in performing a cell selection.

In some embodiments, before the sending slice routing information to an access network, the method further includes:

receiving slice support information sent by the access network; and

generating the slice routing information based on the slice support information.

In some embodiments, the slice routing information includes at least one of the following:

a core network routing function index list;

a slice index list; and

a slice group index list.

In some embodiments, at least part of a slice index in the slice index list is in correspondence to a slice.

In some embodiments, at least part of a slice group index in the slice group index list is in correspondence to a slice combination.

In some embodiments, the cell assistance information includes at least one of the following:

cell identity information;

tracking area identity information;

core network routing function index information;

slice index information;

slice group index information;

frequency information; and

frequency band information.

It should be noted that this embodiment serves as an implementation of the core network device corresponding to the embodiment shown in FIG. 2. For implementations of this embodiment, reference may be made to related description of the embodiment shown in FIG. 2, with the same effects achieved. To avoid repetition, details are not described herein again.

Referring to FIG. 5, FIG. 5 is a flowchart of anther cell selection control method according to an embodiment of the present application. The method is applied to an access network device. As shown in FIG. 5, the method includes the following step.

Step 501: Send cell assistance information, where the cell assistance information is used to assist a terminal in selecting an accessed cell.

In some embodiments, the cell assistance information includes at least one of the following:

cell identity information;

tracking area identity information;

core network routing function index information;

slice index information;

slice group index information;

frequency information; and

frequency band information.

In some embodiments, before the sending cell assistance information, the method further includes:

receiving slice routing information sent by a core network; and

generating the cell assistance information based on the slice routing information.

In some embodiments, the slice routing information includes at least one of the following:

a core network routing function index list;

a slice index list; and

a slice group index list.

In some embodiments, at least part of a slice index in the slice index list is in correspondence to a slice.

In some embodiments, at least part of a slice group index in the slice group index list is in correspondence to a slice combination.

In some embodiments, before the receiving slice routing information sent by a core network, the method further includes:

sending slice support information to the core network, where the slice support information is used for the core network to generate the slice routing information.

It should be noted that this embodiment serves as an implementation of the access network device corresponding to the embodiment shown in FIG. 2. For implementations of this embodiment, reference may be made to related description of the embodiment shown in FIG. 2, with the same effects achieved. To avoid repetition, details are not described herein again.

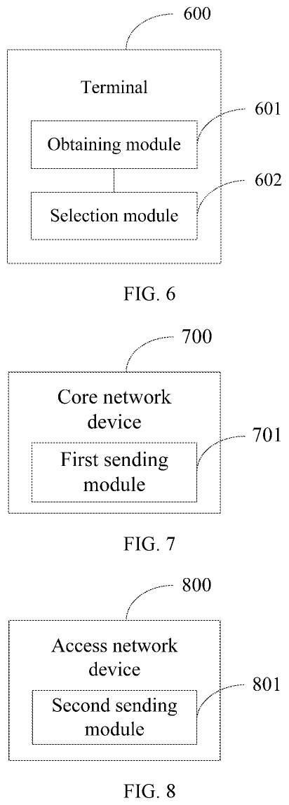

Referring to FIG. 6, FIG. 6 is a structural diagram of a terminal according to an embodiment of the present application. As shown in FIG. 6, the terminal 600 includes:

an obtaining module 601, configured to obtain cell assistance information of an access network; and

a selection module 602, configured to perform a cell selection based on the cell assistance information and slice assistance information, where the slice assistance information is used to assist in performing the cell selection.

In some embodiments, the slice assistance information includes at least one of the following:

a correspondence between a slice and a slice index;

a slice index list;

a correspondence between the slice and a slice group index;

a slice group index list;

a correspondence between the slice and a cell;

a cell identity list;

a correspondence between the slice and a tracking area;

a tracking area identity list;

a correspondence between the slice and a core network routing function;

a core network routing function index list;

a correspondence between the slice and a frequency;

a frequency list;

a correspondence between the slice and a frequency band; and

a frequency band list.

In some embodiments, the slice assistance information is information that is pre-configured or sent by a core network.

In some embodiments, the cell assistance information includes at least one of the following:

cell identity information;

tracking area identity information;

core network routing function index information;

slice index information;

slice group index information;

frequency information; and

frequency band information.

In some embodiments, the selection module 602 is configured to perform at least one of the following:

selecting an accessed cell in a first cell, where cell assistance information of the first cell overlaps slice related information, and the slice related information includes part or all of the slice assistance information; and

setting a second cell as an access-forbidden cell, or setting a frequency of the second cell as an access-forbidden frequency, where cell assistance information of the second cell does not overlap the slice related information.

The terminal provided in this embodiment of the present application can implement the processes implemented by the terminal in the method embodiment in FIG. 2. To avoid repetition, details are not described herein again.

Referring to FIG. 7, FIG. 7 is a structural diagram of a core network device according to an embodiment of the present application. As shown in FIG. 7, the core network device 700 includes:

a first sending module 701, configured to send slice assistance information to a terminal, where the slice assistance information is used to assist the terminal in performing a cell selection.

In some embodiments, the slice assistance information includes at least one of the following:

a correspondence between a slice and a slice index;

a slice index list;

a correspondence between the slice and a slice group index;

a slice group index list;

a correspondence between the slice and a cell;

a cell identity list;

a correspondence between the slice and a tracking area;

a tracking area identity list;

a correspondence between the slice and a core network routing function;

a core network routing function index list;

a correspondence between the slice and a frequency;

a frequency list;

a correspondence between the slice and a frequency band; and

a frequency band list.

In some embodiments, the first sending module 701 is further configured to:

send slice routing information to an access network, where the slice routing information is used for the access network to generate cell assistance information, and the cell assistance information is used to assist the terminal in performing the cell selection.

In some embodiments, the core network device 700 further includes:

a first receiving module, configured to receive slice support information sent by the access network; and

a first generation module, configured to generate the slice routing information based on the slice support information.

In some embodiments, the slice routing information includes at least one of the following:

a core network routing function index list;

a slice index list; and

a slice group index list.

In some embodiments, at least part of a slice index in the slice index list is in correspondence to a slice.

In some embodiments, at least part of a slice group index in the slice group index list is in correspondence to a slice combination.

In some embodiments, the cell assistance information includes at least one of the following:

cell identity information;

tracking area identity information;

core network routing function index information;

slice index information;

slice group index information;

frequency information; and

frequency band information.

The network device provided in this embodiment of the present application can implement various processes implemented by the core network device in the method embodiment of FIG. 4. To avoid repetition, details are not described herein again.

Referring to FIG. 8, FIG. 8 is a structural diagram of an access network device according to an embodiment of the present application. As shown in FIG. 8, the access network device 800 includes:

a second sending module 801, configured to send cell assistance information, where the cell assistance information is used to assist a terminal in selecting an accessed cell.

In some embodiments, the cell assistance information includes at least one of the following:

cell identity information;

tracking area identity information;

core network routing function index information;

slice index information;

slice group index information;

frequency information; and

frequency band information.

In some embodiments, the access network device 800 further includes:

a second receiving module, configured to receive slice routing information sent by a core network; and

a second generation module, configured to generate the cell assistance information based on the slice routing information.

In some embodiments, the slice routing information includes at least one of the following:

a core network routing function index list;

a slice index list; and

a slice group index list.

In some embodiments, at least part of a slice index in the slice index list is in correspondence to a slice.

In some embodiments, at least part of a slice group index in the slice group index list is in correspondence to a slice combination.

In some embodiments, the second sending module is further configured to send slice support information to the core network, where the slice support information is used for the core network to generate the slice routing information.

The network device provided in this embodiment of the present application can implement the processes implemented by the access network device in the method embodiment of FIG. 5. To avoid repetition, details are not described herein again.

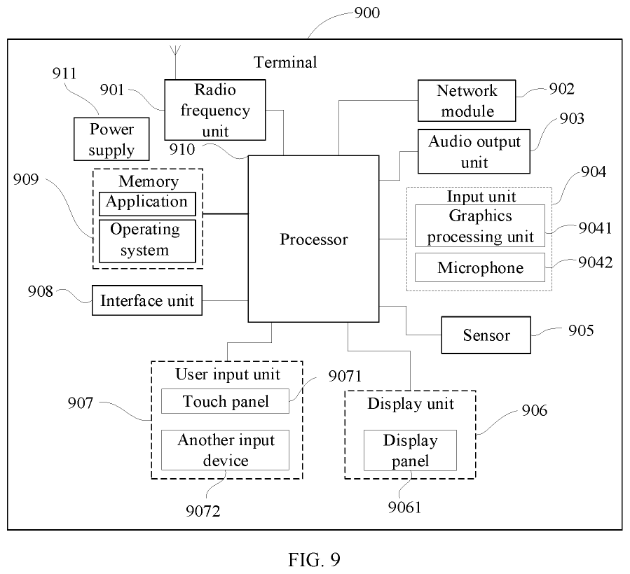

FIG. 9 is a schematic diagram of a hardware structure of a terminal for implementing the embodiments of the present application.

The terminal 900 includes but is not limited to components such as a radio frequency unit 901, a network module 902, an audio output unit 903, an input unit 904, a sensor 905, a display unit 906, a user input unit 907, an interface unit 908, a memory 909, a processor 910, and a power supply 911. A person skilled in the art can understand that a structure of the terminal shown in FIG. 9 does not constitute a limitation on the terminal, where the terminal may include more or fewer components than those shown in the figure, or combine some components, or have different component arrangements. In this embodiment of the present application, the terminal includes but is not limited to a mobile phone, a tablet computer, a notebook computer, a palmtop computer, an in-vehicle terminal, a wearable device, a pedometer, and the like.

The radio frequency unit 901 is configured to obtain cell assistance information of an access network.

The processor 910 is configured to perform a cell selection based on the cell assistance information and slice assistance information. The slice assistance information is used to assist in performing the cell selection.

It should be understood that, in this embodiment, the foregoing processor 910 and the radio frequency unit 901 can implement various processes implemented by the terminal in the method embodiment in FIG. 2. To avoid repetition, details are not described herein again.

It should be understood that, in this embodiment of the present application, the radio frequency unit 901 may be configured to receive and send information or a signal in a call process. In some embodiments, after receiving downlink data from a base station, the radio frequency unit 901 sends the downlink data to the processor 910 for processing. In addition, the radio frequency unit 901 sends uplink data to the base station. Usually, the radio frequency unit 901 includes but is not limited to an antenna, at least one amplifier, a transceiver, a coupler, a low noise amplifier, a duplexer, and the like. In addition, the radio frequency unit 901 may also communicate with a network and another device through a wireless communications system.

The terminal provides wireless broadband Internet access to a user through the network module 902, for example, helps the user receive and send e-mails, browse web pages, access streaming media, and the like.

The audio output unit 903 may convert audio data received by the radio frequency unit 901 or the network module 902 or stored in the memory 909 into an audio signal and output the audio signal as a sound. In addition, the audio output unit 903 may further provide an audio output (for example, a call signal received voice, or a message received voice) related to a function implemented by the terminal 900. The audio output unit 903 includes a loudspeaker, a buzzer, a telephone receiver, and the like.

The input unit 904 is configured to receive an audio signal or a video signal. The input unit 904 may include a Graphics Processing Unit (GPU) 9041 and a microphone 9042. The graphics processing unit 9041 processes image data of a static picture or video obtained by an image capture apparatus (such as a camera) in a video capture mode or an image capture mode. A processed image frame may be displayed on the display unit 906. The image frame processed by the graphics processing unit 9041 may be stored in the memory 909 (or another storage medium) or sent by using the radio frequency unit 901 or the network module 902. The microphone 9042 may receive a sound and can process such sound into audio data. The processed audio data may be converted in a call mode into a format that can be sent by the radio frequency unit 901 to a mobile communication base station for outputting.

The terminal 900 further includes at least one sensor 905, for example, a light sensor, a motion sensor, and another sensor. In some embodiments, the light sensor includes an ambient light sensor and a proximity sensor. The ambient light sensor may adjust luminance of the display panel 9061 based on brightness of ambient light. The proximity sensor may turn off the display panel 9061 and/or backlight when the terminal 900 is moved to an ear. As a type of the motion sensor, an accelerometer sensor can detect magnitude of acceleration in each direction (generally, on three axes), and may detect magnitude and a direction of gravity when being static. The accelerometer sensor may be used for recognizing a terminal gesture (for example, portrait and landscape orientation switching, a related game, or magnetometer posture calibration), a function related to vibration recognition (for example, a pedometer or a strike), or the like. The sensor 905 may further include a fingerprint sensor, a pressure sensor, an iris sensor, a molecular sensor, a gyroscope, a barometer, a hygrometer, a thermometer, an infrared sensor, and the like. Details are not described herein.

The display unit 906 is configured to display information input by a user or information provided for a user. The display unit 906 may include the display panel 9061, and the display panel 9061 may be configured in a form of a Liquid Crystal Display (LCD), an Organic Light-Emitting Diode (OLED), or the like.

The user input unit 907 may be configured to receive input digit or character information and generate key signal input related to user setting and function control of the terminal. In some embodiments, the user input unit 907 includes a touch panel 9071 and another input device 9072. The touch panel 9071 is also referred to as a touchscreen, and may collect a touch operation performed by a user on or near the touch panel 9071 (for example, an operation performed by a user on the touch panel 9071 or near the touch panel 9071 by using any proper object or accessory, for example, a finger or a stylus). The touch panel 9071 may include two parts: a touch detection apparatus and a touch controller. The touch detection apparatus detects a touch location of the user, detects a signal brought by the touch operation, and sends the signal to the touch controller. The touch controller receives touch information from the touch detection apparatus, converts the touch information into touch point coordinates, sends the touch point coordinates to the processor 910, and receives and executes a command sent by the processor 910. In addition, the touch panel 9071 may be implemented in various types such as a resistor, a capacitor, an infrared ray, or a surface acoustic wave. The user input unit 907 may include other input devices 9072 in addition to the touch panel 9071. In some embodiments, the another input device 9072 may include but is not limited to: a physical keyboard, function keys (for example, a volume control key and an on/off key), a trackball, a mouse, or a joystick. Details are not described herein.

Further, the touch panel 9071 may cover the display panel 9061. After detecting the touch operation on or near the touch panel 9071, the touch panel 9071 transmits the touch operation to the processor 910 to determine a type of a touch event, and then the processor 910 provides corresponding visual output on the display panel 9061 based on the type of the touch event. In FIG. 9, the touch panel 9071 and the display panel 9061 are used as two independent components to implement input and output functions of the terminal. However, in some embodiments, the touch panel 9071 and the display panel 9061 may be integrated to implement the input and output functions of the terminal. This is not specifically limited herein.

The interface unit 908 is an interface connecting an external apparatus to the terminal 900. For example, the external apparatus may include a wired or wireless headphone port, an external power supply (or a battery charger) port, a wired or wireless data port, a storage card port, a port used to connect to an apparatus having an identity module, an audio input/output (I/O) port, a video I/O port, a headset port, and the like. The interface unit 908 may be configured to receive input (for example, data information and power) from the external apparatus and transmit the received input to one or more elements in the terminal 900, or may be configured to transmit data between the terminal 900 and the external apparatus.

The memory 909 may be configured to store a software program and various data. The memory 909 may mainly include a program storage area and a data storage area. The program storage area may store an operating system, an application required by at least one function (for example, a sound play function or an image display function), and the like. The data storage area may store data (for example, audio data or an address book) or the like created based on use of a mobile phone. In addition, the memory 909 may include a high-speed random access memory, and may further include a nonvolatile memory, for example, at least one magnetic disk storage device, a flash storage device, or another volatile solid-state storage device.

The processor 910 is a control center of the terminal, and connects all parts of the entire terminal by using various interfaces and lines. By running or executing a software program and/or a module stored in the memory 909 and invoking data stored in the memory 909, the processor performs various functions of the terminal and data processing, to perform overall monitoring on the terminal. The processor 910 may include one or more processing units. In some embodiments, the processor 910 may be integrated with an application processor and a modem processor. The application processor mainly processes an operating system, a user interface, an application program, and the like, and the modem processor mainly processes wireless communication. It can be understood that the modem processor may not be integrated into the processor 910.

The terminal 900 may further include a power supply 911 (such as a battery) that supplies power to each component. In some embodiments, the power supply 911 may be logically connected to the processor 910 by using a power management system, to implement functions such as charging, discharging, and power consumption management by using the power management system.

In addition, the terminal 900 includes some function modules not shown, and details are not described herein.

In some embodiments, an embodiment of the present application further provides a terminal, including a processor 910, a memory 909, and a program or an instruction stored in the memory 909 and capable of running on the processor 910. When the program or the instruction is executed by the processor 910, the processes of the foregoing cell selection method embodiments are implemented, with the same technical effects achieved. To avoid repetition, details are not described herein again.

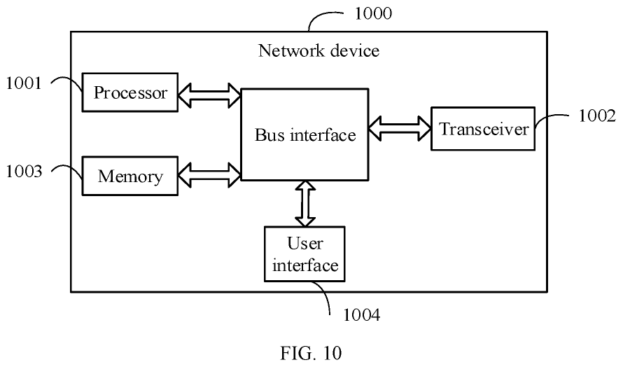

Referring to FIG. 10, FIG. 10 is a structural diagram of another network device according to an embodiment of the present application. As shown in FIG. 10, the network device 1000 includes a processor 1001, a transceiver 1002, a memory 1003, and a bus interface.

The transceiver 1002 is configured to:

send slice assistance information to a terminal, where the slice assistance information is used to assist the terminal in performing a cell selection; or

send cell assistance information, where the cell assistance information is used to assist the terminal in selecting an accessed cell.

It should be understood that in this embodiment, the processor 1001 and the transceiver 1002 can implement the processes implemented by the network device in the method embodiments shown in FIG. 4 or FIG. 5. To avoid repetition, details are not described herein again.

In FIG. 10, a bus architecture may include any quantity of interconnected buses and bridges, and is linked by various circuits of one or more processors represented by the processor 1001 and a memory represented by the memory 1003. The bus architecture may further link various other circuits such as a peripheral device, a voltage regulator, and a power management circuit together. These are all well-known in the art, and therefore are not further described in this specification. The bus interface provides interfaces. The transceiver 1002 may be a plurality of elements, in other words, includes a transmitter and a receiver, and provides a unit configured to communicate with various other apparatuses on a transmission medium. For different user equipment, the user interface 1004 may be further an interface capable of connecting externally and internally a required device. The connected device includes but is not limited to a keypad, a display, a speaker, a microphone, a joystick, and the like.

The processor 1001 is responsible for managing the bus architecture and common processing, and the memory 1003 may store data used when the processor 1001 performs an operation.

In some embodiments, an embodiment of the present application further provides a network device, including a processor 1001, a memory 1003, and a program or instruction stored in the memory 1003 and capable of running on the processor 1001. When the program or the instruction is executed by the processor 1001, the processes of the foregoing cell selection control method embodiments are implemented, with the same technical effects achieved. To avoid repetition, details are not described herein again.

An embodiment of the present application further provides a readable storage medium, where the readable storage medium stores a program or an instruction, and when the program or the instruction is executed by a processor, the processes of the cell selection control method embodiment according to this embodiment of the present application are implemented, or when the program or the instruction is executed by a processor, the processes of the terminal-side cell selection method embodiments according to this embodiment of the present application are implemented, with the same technical effects achieved. To avoid repetition, details are not described herein again. The readable storage medium is, for example, a Read-Only Memory (ROM), a Random Access Memory (RAM), a magnetic disk, or an optical disc.

An embodiment of the present application also provides a chip. The chip includes a processor and a communications interface, and the communications interface is coupled to the processor. The processor is configured to run a program or an instruction to implement various processes of the foregoing cell selection method or the cell selection control method embodiment, with the same technical effects achieved. To avoid repetition, details are not described herein again.

It should be understood that the chip mentioned in this embodiment of the present application may also be referred to as a system-level chip, a system chip, a system on chip, a system chip on chip, and the like. It should be noted that, in this specification, the terms “include”, “comprise”, or any of their variants are intended to cover a non-exclusive inclusion, such that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude the presence of additional identical elements in the process, method, article, or apparatus that includes the element. In addition, it should be noted that the scope of the methods and apparatuses in the embodiments of the present application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

By means of the foregoing description of the embodiments, a person skilled in the art may clearly understand that the method in the foregoing embodiments may be implemented by software in addition to a necessary universal hardware platform. The method in the foregoing embodiments may also be implemented by hardware. However, in many cases, the former is an exemplary embodiment. Based on such an understanding, the technical solutions of this application essentially, or the part contributing to the prior art may be implemented in a form of a software product. The software product is stored in a storage medium (for example, ROM/RAM, a magnetic disk, or an optical disc), and includes several instructions for instructing a terminal (which may be a mobile phone, a computer, a server, an air conditioner, a base station, or the like) to perform the method described in the embodiments of the present application.

The embodiments of this application are described above with reference to the accompanying drawings, but this application is not limited to the foregoing implementation manners. The foregoing implementation manners are merely schematic instead of restrictive. Under enlightenment of this application, a person of ordinary skills in the art may make many forms without departing from aims and the protection scope of claims of this application, all of which fall within the protection scope of this application.

1. A cell selection method, performed by a terminal, comprising:
obtaining cell assistance information of an access network; and
based on the cell assistance information and slice assistance information, performing a cell selection, wherein the slice assistance information is used to assist in performing the cell selection.

2. The cell selection method according to claim 1,
wherein:
the slice assistance information comprises at least one of the following:
a correspondence between a slice and a slice index;
a slice index list;
a correspondence between the slice and a slice group index;
a slice group index list;
a correspondence between the slice and a cell;
a cell identity list;
a correspondence between the slice and a tracking area;
a tracking area identity list;
a correspondence between the slice and a core network routing function;
a core network routing function index list;
a correspondence between the slice and a frequency;
a frequency list;
a correspondence between the slice and a frequency band; or
a frequency band list, and
the cell assistance information comprises at least one of the following:
cell identity information;
tracking area identity information;
core network routing function index information;
slice index information;
slice group index information;
frequency information; or
frequency brand information.

3. The cell selection method according to claim 1, wherein the cell selection comprises at least one of the following:
selecting an accessed cell in a first cell, wherein cell assistance information of the first cell overlaps slice related information, and the slice related information comprises part or all of the slice assistance information; or
setting a second cell as an access-forbidden cell, or setting a frequency of the second cell as an access-forbidden frequency, wherein non-intersection is between cell assistance information of the second cell and the slice related information.

4. A cell selection control method, performed by a core network device, comprising:
sending slice assistance information to a terminal, wherein the slice assistance information is used to assist the terminal in performing a cell selection.

5. The cell selection control method according to claim 4, wherein the slice assistance information comprises at least one of the following:
a correspondence between a slice and a slice index;
a slice index list;
a correspondence between the slice and a slice group index;
a slice group index list;
a correspondence between the slice and a cell;
a cell identity list;
a correspondence between the slice and a tracking area;
a tracking area identity list;
a correspondence between the slice and a core network routing function;
a core network routing function index list;
a correspondence between the slice and a frequency;
a frequency list;
a correspondence between the slice and a frequency brand; or
a frequency brand list.

6. The cell selection control method according to claim 4, wherein before the sending slice assistance information to a terminal, the method further comprises:
sending slice routing information to an access network, wherein the slice routing information is used for the access network to generate cell assistance information, and the cell assistance information is used to assist the terminal in performing the cell selection.

7. The cell selection control method according to claim 6, wherein before the sending slice routing information to an access network, the method further comprises:
receiving slice support information sent by the access network; and
generating the slice routing information based on the slice support information.

8. The cell selection control method according to claim 6, wherein the slice routing information comprises at least one of the following:
a core network routing function index list;
a slice index list; or
a slice group index list.

9. The cell selection control method according to claim 8, wherein at least a part of a slice index in the slice index list is in correspondence to a slice, or at least part of a slice group index in the slice group index list is in correspondence to a slice combination.

10. The cell selection control method according to claim 6, wherein the cell assistance information comprises at least one of the following:
cell identity information;
tracking area identity information;
core network routing function index information;
slice index information;
slice group index information;
frequency information; or
frequency brand information.

11. A cell selection control method, performed by an access network device, comprising:
sending cell assistance information, wherein the cell assistance information is used to assist a terminal in selecting an accessed cell.

12. The cell selection control method according to claim 11, wherein the cell assistance information comprises at least one of the following:
cell identity information;
tracking area identity information;
core network routing function index information;
slice index information;
slice group index information;
frequency information; or
frequency brand information.

13. The cell selection control method according to claim 11, wherein before the sending cell assistance information, the method further comprises:
receiving slice routing information sent by a core network; and
generating the cell assistance information based on the slice routing information.

14. The cell selection control method according to claim 13, wherein the slice routing information comprises at least one of the following:
a core network routing function index list;
a slice index list; or
a slice group index list.

15. The cell selection control method according to claim 14, wherein at least part of a slice index in the slice index list is in correspondence to a slice.

16. The cell selection control method according to claim 14, wherein at least part of a slice group index in the slice group index list is in correspondence to a slice combination.

17. The cell selection control method according to claim 13, wherein before the receiving slice routing information sent by a core network, the method further comprises:
sending slice support information to the core network, wherein the slice support information is used for the core network to generate the slice routing information.

18. A terminal, comprising: a memory having a computer program stored thereon; and a processor, wherein the computer program, when executed by the processor, causes the processor to perform the cell selection method of claim 1.

19. A core network device, comprising: a memory having a computer program stored thereon; and a processor, wherein the computer program, when executed by the processor, causes the processor to perform the cell selection control method of claim 4.

20. An access network device, comprising: a memory having a computer program stored thereon; and a processor, wherein the computer program, when executed by the processor, causes the processor to perform the cell selection control method of claim 11.
